(19) United States
(12) Patent Application Publication
(10) Pub. No.: US 2012/0110605 A1
(43) Pub. Date: May 3, 2012

(54) Optical Disc Drive

(75) Inventors: In Shuen Lee, Hsinchu (TW); Yuan-Yu Lee, Hsinchu (TW); Hui Chung Leu, Hsinchu (TW)

(73) Assignee: LITE-ON IT CORPORATION, Taipei City (TW)

(21) Appl. No.: 13/085,641

(22) Filed: Apr. 13, 2011

(30) Foreign Application Priority Data
Nov. 3, 2010 (CN) 201010535265.3

(51) Int. Cl. G11B 17/02

(52) U.S. Cl. 720/695; G9B/17.002

(57) ABSTRACT

An optical disc drive is provided to comprise a main circuit board; an optical pickup head, electrically connected to the main circuit board for reading data from an optical disc and for writing a label side of the optical disc; an spindle motor module, electrically connected to the main circuit board through a first flexible flat cable for supporting and rotating the optical; and a spoke detecting module, electrically connected to the main circuit board through a second flexible flat cable for detecting a spoke pattern formed on inner radius of the label side of the optical disc.

This application claims the benefit of People's Republic of China application Serial No. 201010535265.3, filed Nov. 3, 2010, the subject matter of which is incorporated herein by reference.

### BACKGROUND OF THE INVENTION

1. Field of the Invention

The invention relates in general to an optical disc drive, and more particularly to an optical disc drive with label side writing technology.

2. Description of the Related Art

The production of the optical disc writing technology makes people can store data in the writable optical disc. In general, after completing the data storing, people usually use pen to write notes or paste labels on label side of the optical disc to show the content of the stored data. However, the labels marked by these ways will become unrecognizable or disappear after a period of time, therefore, causing inconvenience of user. Accordingly, the Lightscribe Optical Disc Drive is developed recently, which can writing patterns or words on the label side of the optical disc.

When writing patterns or words on the label side of the optical disc, because the label side does not have preformed tracks for address position function as like the data side, the control and judgment of the rotary position of the label side is achieved by the spoke pattern formed at inner radius of the label side and the spoke detector.

In general, the spoke detector includes a light emitter and a light detector. When the light emitter emits light on the spoke pattern, the reflective light will be received by the light detector, and a spoke signal is produced. Then, the optical disc drive can obtain the rotary position of the label side according to the spoke signal, therefore, to control and judge the rotary position of the label side of the optical disc drive. Besides the rotary position, the radius position of the label side of the optical disc can be obtained by controlling the position of the optical pickup head. Therefore, the optical disc drive can write patterns or words at designated position on the label side of the optical disc.

In the traditional optical disc drive, the spoke detector is disposed on the spindle motor circuit board, and the spindle motor circuit board electrically connects to the main circuit board disposed inside the optical disc drive by a flexible flat cable for transmitting control signals there between. As both of the spoke signals produced from the spoke detector and the control signals produced from the spindle motor are transmitted to the main circuit board by the same flexible flat cable, the flexible flat cable should be designed to contain enough channels to transmit the spoke signals and the control signals at the same time. Moreover, the connectors for connecting to the terminals of the flexible flat cable should be designed to contain enough pins.

However, the more channels and the more pins designs mean the more costs. Besides, in the optical disc drive, the label side writing technology is not an essential function that should be implemented in the optical disc drive. In order to reduce the design change, the designs of the channels of the flexible flat cable and the pins of the connectors are corresponded to the designs of the optical disc drive having the label side writing technology, which means to use more channels and pins. For the optical disc drive without the label side writing technology, it only needs to remove the spoke detector and does not need additional design change. However, under this situation, the costs of the additional channels and pins for transmitting the spoke signal produced from the spoke detector can not be avoided.

### SUMMARY OF THE INVENTION

Accordingly, the invention provides an assembling method and structure of an optical disc drive that can efficiently reduce the width of the optical disc drive without changing the design of the internal elements of the optical disc drive and raise the competition position of the optical disc drive in the market.

According to a first aspect of the present invention, an optical disc drive is provided to comprise a main circuit board; an optical pickup head electrically connected to the main circuit board for reading data from an optical disc and for writing a label side of the optical disc; an spindle motor module having a spindle motor for supporting and rotating the optical; a spoke detecting module having a spoke detector for detecting a spoke pattern formed on inner radius of the label side of the optical disc; a first flexible flat cable, wherein one end of which is connected to the spindle motor module, and the other end is connected to the main circuit board; and a second flexible flat cable, wherein one end of which is connected to the spoke detecting module, and the other end is connected to the main circuit board.

According to a second aspect of the present invention, an optical disc drive is provided to comprise a main circuit board; an optical pickup head, electrically connected to the main circuit board for reading data from an optical disc and for writing a label side of the optical disc; an spindle motor module, electrically connected to the main circuit board through a first flexible flat cable for supporting and rotating the optical; and a spoke detecting module, electrically connected to the main circuit board through a second flexible flat cable for detecting a spoke pattern formed on inner radius of the label side of the optical disc.

### BRIEF DESCRIPTION OF THE DRAWINGS

The invention will become apparent from the following detailed description of the preferred but non-limiting embodiments. The following description is made with reference to the accompanying drawings.

FIG. 1 shows an optical disc drive wherein the case is removed according to a preferred embodiment of the present invention;

FIG. 2 shows a front side view of a spindle motor module, a spoke detecting module and a main circuit board according to the preferred embodiment of the present invention;

FIG. 3 shows a back side view of FIG. 2; and

FIG. 4 shows a perspective view of FIG. 3 wherein the spindle motor circuit board is removed.

### DETAILED DESCRIPTION OF THE INVENTION

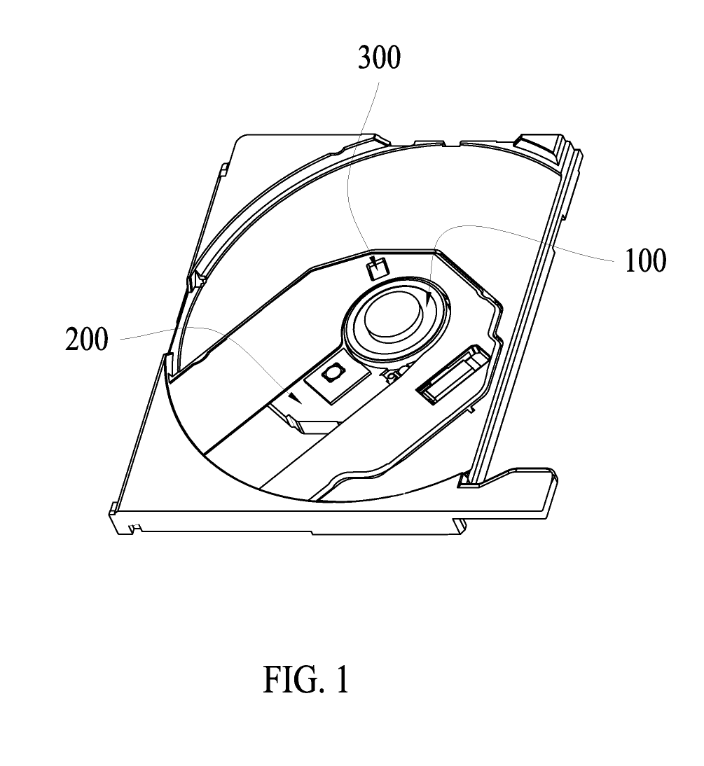

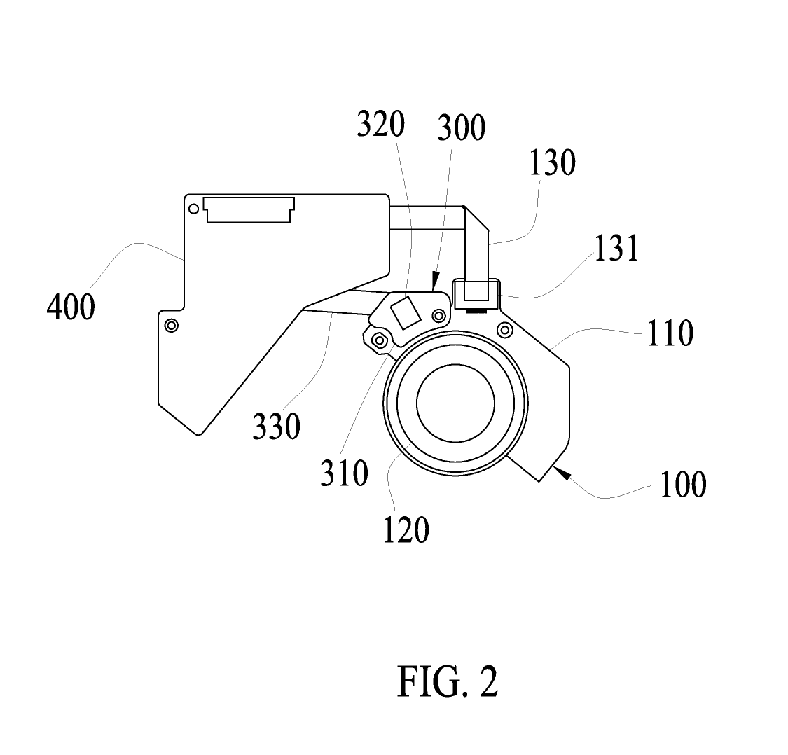

Please refer to FIG. 1 and FIG. 2. FIG. 1 shows an optical disc drive wherein the case is removed according to a preferred embodiment of the present invention, and FIG. 2 shows a front side view of a spindle motor module, a spoke detecting module and a main circuit board according to the preferred embodiment of the present invention.

The optical disc drive according to the preferred embodiment of the present invention comprises a spindle motor module 100, an optical pickup head 200, a spoke detecting module 300 and a main circuit board 400. The main circuit board has processors and related circuits (not shown) for controlling the operation of the optical disc drive. The spindle motor module 100 includes a spindle motor circuit board 110, a spindle motor 120 and a spindle motor flexible flat cable 130. The spindle motor 120 is disposed on the spindle motor circuit board 110 for supporting and rotating an optical disc. The optical pickup head 200 is electrically connected to the main circuit board 400 for reading and writing data from/to the data side of the optical disc and for writing patterns or words on the label side of the optical disc drive. The spoke detecting module 300 includes a spoke detecting circuit board 310, a spoke detector 320 and a spoke detecting flexible flat cable 330. The spoke detector 320 is disposed on the spoke detecting circuit board 310 for detecting the spoke patterns formed on the inner radius of the label side of the optical disc, therefore, to judge the rotary position of the optical disc.

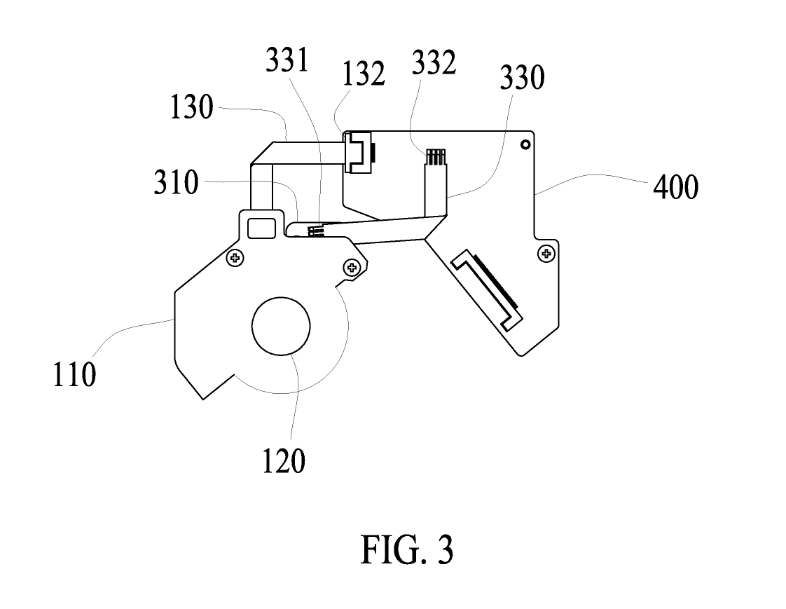

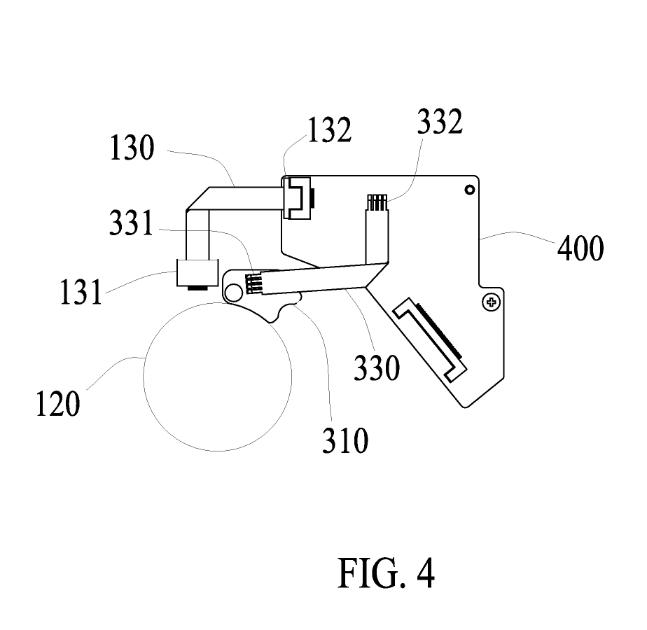

Next, please refer to FIG. 2, FIG. 3 and FIG. 4. FIG. 2 and FIG. 3 respectively show a front side view and a back side view of the spindle motor module, the spoke detecting module and the main circuit board according to the preferred embodiment of the present invention. FIG. 4 shows a perspective view of FIG. 3 wherein the spindle motor circuit board is removed.

In the preferred embodiment of the present invention, a first end 131 of the spindle motor flexible flat cable 130 is connected to the spindle motor circuit board 110, and a second end 132 of the spindle motor flexible flat cable 130 is connected to the main circuit board 400. The processor disposed on the main circuit board 400 transmits the control signals related to the spindle motor to the spindle motor circuit board 110 through the spindle motor flexible flat cable 130 for controlling the rotating speed of the spindle motor 120.

In the preferred embodiment of the present invention, the spindle motor circuit board 110 and the main circuit board 400 have a respective cable connector for respectively connecting to the first end 131 and the second end 132 of the spindle motor flexible flat cable 130. However, the connection between the spindle motor flexible flat cable 130 with the spindle motor circuit board 110 and the main circuit board 400 can be achieved by soldering method or other connecting methods.

In the preferred embodiment of the present invention, a first end 331 of the spoke detecting flexible flat cable 330 is connected to the spoke detecting circuit board 310, and a second end 332 of the spoke detecting flexible flat cable 330 is connected to the main circuit board 400. When writing the patterns or words on the label side of the optical disc, the spoke detector 320 detects the spoke pattern formed on the inner radius of the label side of the optical disc, therefore, to produce a spoke signal and transmit the spoke signal to the main circuit board 400 through the spoke detecting flexible flat cable 330. Accordingly, the processor disposed on the main circuit board 400 can control the rotary position of the optical disc according to the spoke signal.

In the preferred embodiment of the present invention, the spoke detecting flexible flat cable 330 is connected to the spoke detecting circuit board 310 and the main circuit board 400 by the way of solder. However, in the present invention, the connecting way between the flexible flat cable and the circuit board is not limited.

According to the optical disc drive provided in the present invention, the spindle motor module and the spoke detecting module are individually disposed in the optical disc drive and transmit their own signal to the main circuit board by respective flexible flat cable. Therefore, when the optical disc drive manufactories would like to produce the optical disc drive without the label side writing function, they only need to remove the spoke detecting module and do not have to change design. Accordingly, the cost of the spoke detecting circuit board, the spoke detector and the spoke detecting flexible flat cable is saved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical disc drive comprising:
a main circuit board;
an optical pickup head, electrically connected to the main circuit board for reading data from an optical disc and for writing a label side of the optical disc;
an spindle motor module, having a spindle motor for supporting and rotating the optical;
a spoke detecting module, having a spoke detector for detecting a spoke pattern formed on inner radius of the label side of the optical disc;
a first flexible flat cable, wherein one end of which is connected to the spindle motor module, and the other end is connected to the main circuit board; and
a second flexible flat cable, wherein one end of which is connected to the spoke detecting module, and the other end is connected to the main circuit board.

2. The optical disc drive according to claim 1, wherein the spindle motor module further comprises a spindle motor circuit board, wherein one end of the first flexible flat cable is connected to the spindle motor circuit board, and the other end is connected to the main circuit board.

3. The optical disc drive according to claim 2, wherein the spindle motor circuit board and the main circuit board respectively has a cable connector for connecting the two ends of the first flexible flat cable respectively.

4. The optical disc drive according to claim 1, wherein the spoke detecting module further includes a spoke detecting circuit board, and one end of the second flexible flat cable is connected to the spoke detecting circuit board, and the other end is connected to the main circuit board.

5. The optical disc drive according to claim 4, wherein the second flexible flat cable is connected the spoke detecting circuit board and the main circuit board by soldering.

6. An optical disc drive comprising:
a main circuit board;
an optical pickup head, electrically connected to the main circuit board for reading data from an optical disc and for writing a label side of the optical disc;
an spindle motor module, electrically connected to the main circuit board through a first flexible flat cable for supporting and rotating the optical; and
a spoke detecting module, electrically connected to the main circuit board through a second flexible flat cable for detecting a spoke pattern formed on inner radius of the label side of the optical disc.

7. The optical disc drive according to claim 6, wherein the spindle motor module comprises a spindle motor circuit board, wherein one end of the first flexible flat cable is connected to the spindle motor circuit board, and the other end is connected to the main circuit board.

8. The optical disc drive according to claim 7, wherein the spindle motor circuit board and the main circuit board respectively has a cable connector for connecting the two ends of the first flexible flat cable respectively.

9. The optical disc drive according to claim 6, wherein the spoke detecting module includes a spoke detecting circuit board, and one end of the second flexible flat cable is connected to the spoke detecting circuit board, and the other end is connected to the main circuit board.

10. The optical disc drive according to claim 9, wherein the second flexible flat cable is connected the spoke detecting circuit board and the main circuit board by soldering.
